(19) United States
(12) Patent Application Publication
(10) Pub. No.: US 2014/0309964 A1
(43) Pub. Date: Oct. 16, 2014

(54) Internal Sensor Based Personalized Pedestrian Location

(71) Applicant: MICROSOFT CORPORATION, Redmond, WA (US)

(72) Inventors: Fan Li, Beijing (CN); Chunshui Zhao, Beijing (CN); Feng Zhao, Bellevue, WA (US)

(73) Assignee: Microsoft Corporation, Redmond, WA (US)

(21) Appl. No.: 13/860,929

(22) Filed: Apr. 11, 2013

(51) Int. Cl. G01B 21/06

(52) U.S. Cl. CPC G01B 21/06
USPC 702/160

(57) ABSTRACT

Step detection and step length estimation techniques may include detecting salient points in sensor data of one or more sensors. A step frequency may be used to estimate the length of a step according to a step length estimation model. The step length estimation model may be adjusted based at least in part on landmark data to better estimate a step length of the user. Additionally or alternatively, an adjusted step length estimation model may be readjusted over time to account for changes in a user, conditions, or both.

### BACKGROUND

Pedestrian modeling, such as walking pattern detection and step length modeling, is often used to model pedestrian behavior for applications such as localization of pedestrian location and monitoring of pedestrian activity for healthcare, among other potential applications. Inertial measurement unit (IMU) sensors, such as accelerometers, and gyroscopes, are often suitable candidates to help build pedestrian models. IMUs are often available in people's everyday life since, for example, people often carry around smart phones with built in IMU sensors. Many current and proposed pedestrian models, however, are unable to provide accurate, position-free, and personalized results.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

This disclosure describes techniques to detect a step taken by a user and to estimate a length of the step using a pedestrian model personalized to the user. Various embodiments contemplate detecting a step, estimating a step length using a step length estimation model, and adjusting the step length estimation model to personalize the model for the user. Additionally or alternatively, an adjusted step length estimation model may be readjusted over time to account for changes in a user, conditions, or both.

### BRIEF DESCRIPTION OF THE DRAWINGS

The Detailed Description is set forth with reference to the accompanying figures. In the figures, the left-most digit(s) of a reference number identifies the figure in which the reference number first appears. The use of the same reference numbers in different figures indicates similar or identical items.

FIG. 1 illustrates an example environment including an example step detection, step length estimation, and personalization system.

FIG. 2 shows a schematic of illustrative landmarks and paths suitable for use with the embodiments shown in FIG. 1.

FIG. 3 shows an illustrative computing device and environment for performing data-parallel computation management.

FIG. 4 is a flowchart of an illustrative process of estimating a step length.

FIG. 5 is a flowchart of an illustrative process of processing data to detect a step as part of the illustrative process shown in FIG. 4.

FIG. 6 is a flowchart of an illustrative process of estimating a step length as part of the illustrative process shown in FIG. 4.

FIG. 7 is a flowchart of an illustrative process of adjusting an estimated step length as part of the illustrative process shown in FIG. 4.

FIG. 8 is a flowchart of an illustrative process of readjusting an estimated step length.

### DETAILED DESCRIPTION

### Overview

This disclosure describes techniques to detect a step taken by a user and to estimate a length of the step using a pedestrian model personalized to the user. Various embodiments contemplate step detection, step length estimation, and step length estimation adjustment. In one embodiment, sensor data may be received from a sensor such as, for example, an accelerometer, a pedometer, a gyroscope, a compass, and the like. Salient points of a same type (such as valleys of a trajectory of magnitudes of the sensor data, or peaks of a trajectory of magnitudes of sensor data) may be detected in the sensor data. Based on a time interval between the detected salient points in the sensor data, a step frequency may be estimated. In some embodiments, a step length of a step may be determined based in part on a combination of the estimated step frequencies of adjacent steps and the sensor data obtained within the time interval. Additionally or alternatively, the step length of the step may be adjusted using landmark data to adjust for differences inherent in a generic step model. Additionally or alternatively, a step length estimation model may be adjusted using landmark data to adjust for differences inherent in a generic step model. Additionally or alternatively, an adjusted step length estimation model may be readjusted over time to account for changes in a user, conditions, or both. Additionally or alternatively, the length estimation model may be adjusted using an online algorithm, an offline algorithm, or both.

An adjusted step estimation model may provide a more accurate estimate of a step length than other step estimation models. A pedestrian model that provides accurate location information without the use of or continuous use of common location services, (e.g., Global Positioning System (GPS)) may be useful in, for example, mapping systems and/or providing navigation. In those situations, use of or continuous use of common location services may be unavailable, impracticable, or undesirable.

### Illustrative Architecture

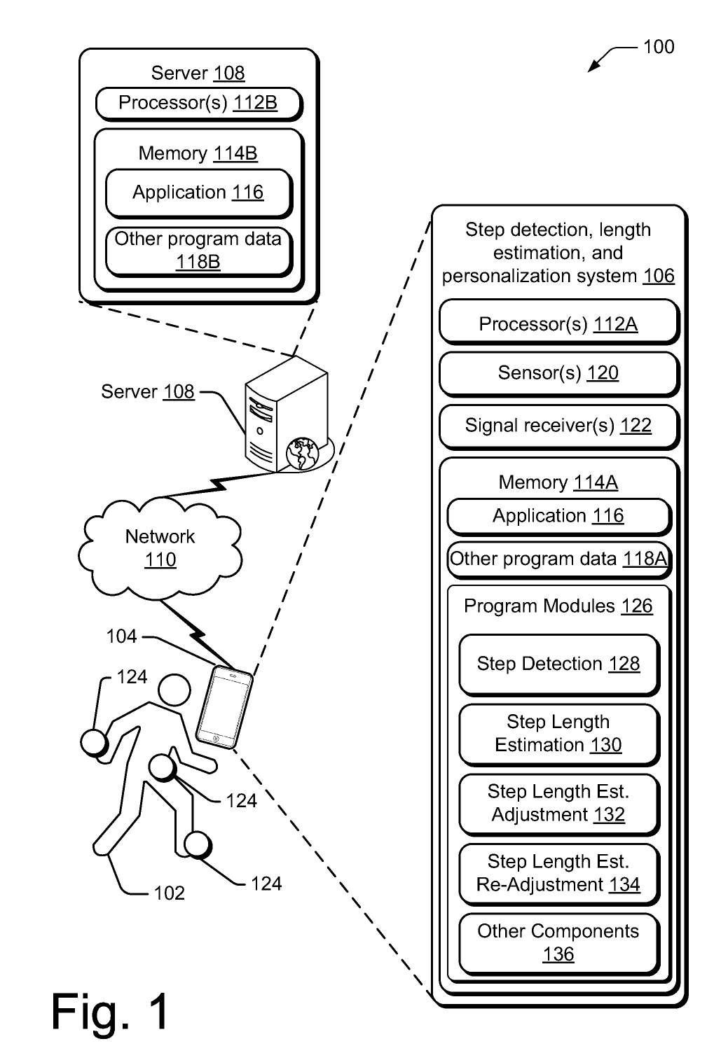

FIG. 1 illustrates an exemplary environment 100 usable to implement step detection, step length estimation, and personalization. The environment 100 may include a user 102 and a client device 104. In one embodiment, the client device 104 may include a step detection, step length estimation, and personalization system 106. In some embodiments, part or all of the step detection, step length estimation, and personalization system 106 may be included in a server 108 that is separate from the client device 104. In that case, the client device 104 may communicate with the step detection, step length estimation, and personalization system 106 through a network 110. In at least one embodiment, functions of the step detection, step length estimation, and personalization system 106 may be included and distributed among multiple devices. For example, the client device 104 may include part of the functions of the step detection, step length estimation, and personalization system 106 while other functions of the step detection, step length estimation, and personalization system 106 may be included in the server 108.

The client device 104 may be implemented as any of a variety of conventional computing devices including, for example, a notebook or portable computer, a handheld device, a netbook, an Internet appliance, a portable reading device, an electronic book reader device, a tablet or slate computer, a game console, a mobile device (e.g., a mobile phone, a personal digital assistant, a smart phone, and the like), a media player, and the like or a combination thereof.

The network 110 may be a wireless or a wired network, or a combination thereof. The network 110 may be a collection of individual networks interconnected with each other and functioning as a single large network (e.g., the Internet or an intranet). Examples of such individual networks include, but are not limited to, telephone networks, cable networks, Local Area Networks (LANs), Wide Area Networks (WANs), and Metropolitan Area Networks (MANs). Further, the individual networks may be wireless or wired networks, or a combination thereof. In one embodiment, the network 110 may include a near field communication channel. Examples of a near field communication channel include, but are not limited to, infrared communication, radio-frequency (RF), Bluetooth®, WiFi®, WiFi® connect, ZigBee®, infrared data association (IrDA), high-frequency modulated visible light and/or modulated audio.

In one embodiment, the client device 104 includes one or more processors 112A coupled to memory 114A. The memory 114A may include one or more applications 116 (e.g., a step detection/step length estimation/personalization application, a navigation application, a map application, a web browser, and the like) and other program data 118A. The memory 114A may be coupled to or associated with, and/or accessible to other devices, such as network servers, routers, and/or other client devices. Additionally or alternatively, the client device 104 may include one or more sensors 120 that may provide data to the client device 104. In one embodiment, the one or more sensors 120 may include, but are not limited to, an accelerometer, a pedometer, a digital compass, a gyroscope, a network signal detector, a near-field communication transmitter or receiver, an image acquisition and recognition system, a GPS receiver, and the like.

Additionally or alternatively, the client device 104 may include a signal receiver 122 that may receive signals from other devices. For example, receiver 122 may receive signals and or information from sensors 124. A sensor 124 may be located somewhere on the user 102. Additionally or alternatively, sensor 124 may be a dedicated device for sensing and transmitting data or sensor 124 may comprise part of, or an entirety, of another device including, but not limited to, a notebook or portable computer, a handheld device, a netbook, an Internet appliance, a portable reading device, an electronic book reader device, a tablet or slate computer, a game console, a mobile device (e.g., a mobile phone, a personal digital assistant, a smart phone, and the like), a media player, a watch, an accelerometer, a pedometer, a digital compass, a gyroscope, a network signal detector, a near-field communication transmitter or receiver, an image acquisition and recognition system, a GPS receiver, and the like or a combination thereof.

The user 102 may want to count the number of steps he/she will make and estimate respective step lengths (or the total distance) of the steps. The user 102 may open the application 116 (e.g., the step detection/step length estimation/personalization application) to perform such a task. Additionally or alternatively, the user 102 may open the application 116 (e.g., the navigation application or the map application) to display a map to navigate an area such as a shopping mall, and the like. Additionally or alternatively, the user 102 may open the application 116 (e.g., a tracking application) to collect location/distance data. In response to opening the application 116, the step detection, step length estimation, and personalization system 106 may be activated to detect steps made by the user 102 and estimate respective step lengths of the steps.

In various embodiments, memory 114A may include program modules 126. For example, the step detection, step length estimation, and personalization system 106 may include a step detection module 128. The step detection module 126 may be configured to detect or determine a step made by the user 102. By way of example and not limitation, the step detection module 126 may detect or determine the endpoints (e.g., the beginning and the end) of a step through one or more sensors 120 of the client device 104. The one or more sensors 120 may obtain sensor data that represents movement of the user 102. In one embodiment, the one or more sensors may include, but are not limited to, an accelerometer, a pedometer, a digital compass, a gyroscope, a network signal detector, a near-field communication transmitter or receiver, an image acquisition and recognition system, a GPS receiver, and the like.

In response to receiving sensor data (e.g., acceleration data from an accelerometer, and the like) representing the movement of the user 102, the step detection module 126 may analyze the sensor data to determine whether a step has been made or completed. In one embodiment, the step detection module 126 may filter the sensor data prior to analyzing the sensor data. The step detection module 126 may filter the sensor data using a low pass filter to reduce noise in the sensor data. By way of example and not limitation, the low pass filter may include, but is not limited to, a Finite Impulse Response (FIR) filter and/or a Biorthogonal Spline Wavelet (BSW) filter. In various embodiments, the step detection module 126 may apply a low pass FIR digital filter with a 3 Hz cut-off frequency. This may filter out the high frequency noise in sensor data, for example, raw accelerometer magnitude data. The order of the filter may be selected according to the sampling rate of sensor, for example, an accelerometer, and often, for 50 Hz sampling rate, the order of FIR filter may be 16. The cut-off frequency may then be set to 3 Hz since, often, a user's walking frequency is lower than 3 Hz.

Regardless of whether filtering is applied to the sensor data, the step detection module 128 may detect or determine a step using a step detection algorithm. For example, the step detection algorithm may search for salient points of a magnitude trajectory of the sensor data (for example, a trajectory of magnitudes of acceleration) to detect whether a new step has occurred. The salient points may include, but are not limited to, inflection points such as peaks or valleys of the trajectory, zero crossing points of the trajectory, among others.

Various embodiments contemplate applying heuristics to further identify steps. For example, identifying steps using peaks as salient points in the filtered sensor data may identify most, if not all, real steps, but may also include false positives. False positives may cause an inflated number of steps that may be caused by signal noise or movement of the client device 104 that is not related to a step taken by the user 102, for example, a bump, bounce, or other movement of the client device 104. A possible heuristic may include, but is not limited to, expecting that a time gap between two successive steps be larger than a minimum value and less than a maximum value. By way of example and not limitation, a minimum value may be approximately 0.32 seconds and a maximum value may be approximately 1 second. Additionally or alternatively, a heuristic may include, but is not limited to, expecting that a minimum difference of acceleration magnitudes in one step is larger than a threshold value. By way of example and not limitation, a difference of acceleration threshold may be 0.2*gravity, where gravity may be the acceleration due to gravity and expressed in units consistent with the sensor data, for example acceleration magnitudes.

Various embodiments contemplate comparing the waveforms of the sensor data to further identify steps. For example, a dynamic time warping (DTW) may be applied to the sensor data. In various embodiments, a lower DTW result between two wave forms may indicate a higher similarity than two wave forms with a higher DTW result. As discussed above, identifying steps using peaks as salient points in the filtered sensor data may identify most, if not all, real steps, but may also include false positives. DTW may be applied to recognize and compare patterns. For example, users normally move their left and right feet alternately. Therefore, it may be expected that the waveforms of two steps with the same walking foot should be similar, i.e., similar waveform are likely reappear every two steps. Various embodiments contemplate a DTW based algorithm to further determine whether a step detected through salient point detection, for example, peak detection, is a real step. For example, if peak detection yields a series of detected steps {S(1), S(2), . . . , S(n)}, then for Si, the algorithm may calculate a DTW similarity factor between S(i−2) and S(i), and if the similarity factor is lower than a given threshold MinDTW, both S(i−2) and S(i) may be determined as a real step, otherwise, S(i) will be temporally set to fake step until S(i+2) arrives, when S(i) may have another chance to be determined as a real step in the case that a similarity factor between S(i) and S(i+2) is lower than MinDTW. In various embodiments, the similarity factor may be calculated as a DTW result of the accelerometer waveform of the two steps. Various embodiments contemplate calculating a DTW result based on a normalized accelerometer waveform. Using normalized data may reduce the influence of amplitude over DTW while maintaining the shape features of waveforms.

In various embodiments, the step detection, step length estimation, and personalization system 106 may include a step length estimation module 130. The step length estimation module 130 may be configured to estimate a step length of a detected step. In one embodiment, the step length estimation module 130 may employ a step model. By way of example and not limitation, the step length estimation module 130 may compute a step frequency of the detected step. In one embodiment, the step length estimation module 130 may determine a time duration for the detected step based on a time interval between detected salient points in the sensor data. In response to determining the time duration for the detected step, the step length estimation module 130 may compute a step frequency of the detected step as a reciprocal of the determined time duration.

In some embodiments, the step length estimation module 130 may select the step model from a step model database that is stored in the program data 118. In various embodiments, the step model database may be stored in local memory 114A of a client device 104, and/or in memory 114B of one or more remote servers 108. For example, a server 108 may include one or more processors 112B coupled to memory 114B. The memory 114B may include one or more applications 116 and other program data 118B. The step model database may include a plurality of step models. The step length estimation module 130 may select a step model from the plurality of step models based on one or more factors. In one embodiment, the one or more factors may include, but are not limited to, personal information of the user 102. The personal information of the user 102 may include, for example, an age, a gender, a height and/or a weight of the user 102.

Additionally or alternatively, an embodiment contemplates a step model that might not require training data prior to a user's use and may be independent of a location on the user. For example, the user device 104 may be carried or located on various locations on user 102, including, but not limited to, a hand/arm/leg/foot/torso/head/neck of the user, a shirt/coat/pant pocket, or a headband/hat/belt/shoe attachment.

Additionally or alternatively, an embodiment contemplates a generic step model. The generic step model may include a plurality of selectable or adjustable parameters. The step length estimation module 130 may adaptively select or adjust a value from a plurality of predefined values for each selectable or adjustable parameter based on the personal information and/or the type of movement of the user 102, for example.

Various embodiments contemplate that the step length estimation module 130 may estimate the step length of a detected step based at least in part on the determined step frequency (or the determined time duration) and/or the sensor data during the time duration of the detected step.

A length of one step may be correlated with both walking frequency and shape of acceleration waveform in that step. Since an orientation of a mobile device may change frequently in most cases, decomposing accelerations to horizontal and vertical directions might not be practical. Often, a magnitude of accelerations may be used. However, since mobile devices may be put into any position on a user's body, the magnitudes of accelerations may vary significantly across different positions even for the same step, e.g., the magnitude changes in stable hand-held case may be much smaller than those in pocket case. In this sense, it might not be suitable to put accelerations into consideration for a position-free step length model. Often, however, a walking frequency may be a stable variable independent of phone positions and orientations. Additionally, actual accelerations in a step may also have a relationship with walking frequency, since, for example, a walking pattern of one person may remain stable for the same walking frequency over a time. Therefore, a frequency based model, may be used to estimate a step length.

Another factor that may affect step length is the speed of the step. Various embodiments contemplate estimating the speed of the step using frequencies of one or more previous steps. Often, walking frequency influences the walking speed. Various embodiments contemplate evaluating the frequency at one preceding step. Equation 1 shows a step length model based on consecutive frequencies.

yᵢ=a₀+a₁*fᵢ+a₂*fᵢ₋₁ (1)

where yᵢ represents the length of step i, fᵢ represents a walking frequency of step i, while fᵢ₋₁ represents the walking frequency of step i−1, and a₀, a₁, a₂ are weighted coefficients. Compared with a linear frequency model that relies on the current frequency only, this model may yield better estimation accuracy. Additionally or alternatively, the model may be extended by looking back for additional steps. For example, Equation 2 shows an embodiment

yᵢ=a₀+a₁*fᵢ+a₂*fᵢ₋₁+ . . . +aₙ*fᵢ₋ₙ (2)

where fᵢ₋ₙ represents a walking frequency of frequency of step i-n and aₙ is a weighted coefficient. Additionally or alternatively, high order functions of these steps may be applied.

Various embodiments contemplate that a walking frequency for one step may be approximated as the reciprocal of a walking period, which may be calculated as the time period between two consecutive detected salient points, for example, two consecutive detected valleys or two consecutive detected peaks.

In various embodiments, the step detection, step length estimation, and personalization system 106 may include a step length adjustment module 132. The step length adjustment module 132 may be configured to adjust the estimated length of a detected step. In one embodiment, the step length adjustment module 132 may adjust the step model to effect a step length estimation adjustment.

In some situations, a generic model of step length may not predict a certain user's step length with a desired accuracy. Often, in those situations, an error ratio between the estimated step length and a measured step length may vary uniformly across different step frequencies. Various embodiments contemplate a personalized model that may apply a personalization factor to a generic model to result in a personalized model. For example, Equation 3 shows an embodiment

yₚₑᵣₛₒₙₐₗ=K*y_{generic} (3)

where K is defined as compensation coefficient, which may reflect a mismatch between a generic and a personal model. Various embodiments contemplate determining the compensation coefficient using landmark data.

For example, two or more landmarks, whose locations may be known and provide a desired level of accuracy, may provide a distance, for example a ground distance, between the two or more landmarks. The distance between the two or more landmarks may be associated with an estimated distance between the two or more landmarks based on a generic model and represented as a tuple (D_{g}, Dₑ), where D_{g} represents the ground distance between two landmarks and Dₑ represents the estimated distance between the two landmarks. Various embodiments contemplate using multiple landmarks and associated distances to generate multiple tuples {(D_{g1}, Dₑ₁), (D_{g2}, Dₑ₂), . . . (D_{gN}, D_{eN})}. Using the multiple tuples, a compensate coefficient K which can minimize the error ratios between estimated distances and ground truth distances may be calculated. Various error calculation methods may be used. For example, an L1-mean of error ratio as the minimizing target may be used. For example, Equation 4 shows an embodiment

$${Min}_{K} \sum {ω}_{i} abs ( 1 - \frac{K * {D}_{ei}}{{D}_{gi}} ) \qquad ( 4 )$$

where ωᵢ may be a weight of tuple (D_{gi}, Dₑᵢ), which may be determined by a confidence level of D_{gi} and Dₑᵢ. Various embodiments contemplate that the confidence level may correlate with a landmark selection method used to select and/or identify the landmark.

Various embodiments contemplate allowing a wide range of objects and information to serve as landmarks. For example, landmarks may be physical or virtual in nature. For example, a landmark may be an intersection of a street or path from a map, a position of a WiFi hotspot, a communication tower, a point with an extreme signal strength of a signal (for example a radio signal of a WiFi access point), and/or the like. A suitable landmark may be stable in location over a period of time and accurate to a desired level of accuracy in terms of location. The landmark may also be detectable by a mobile device.

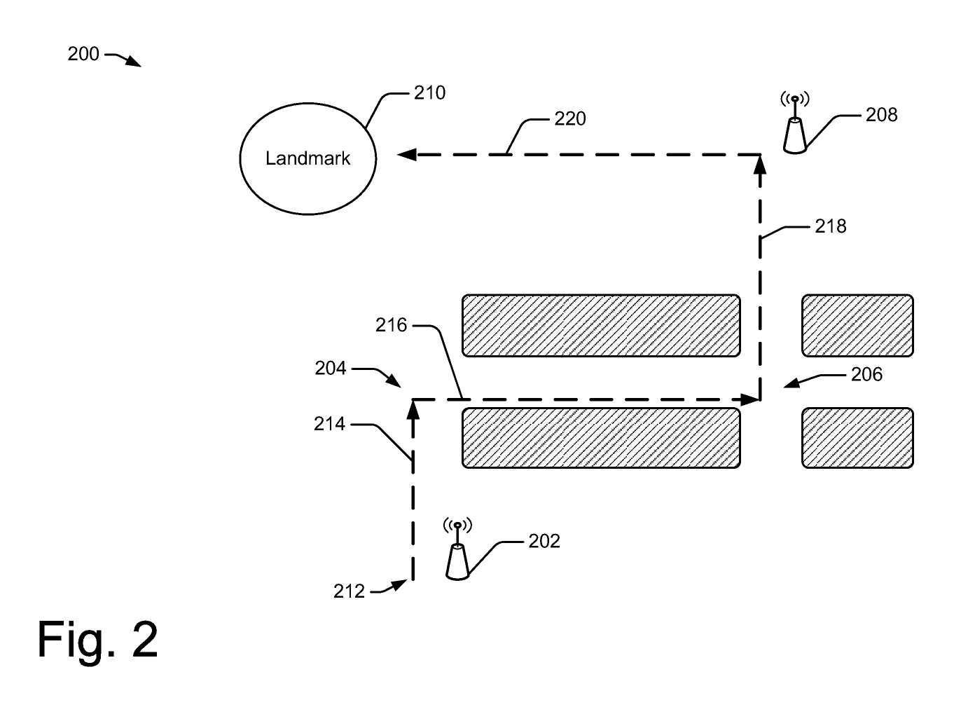

FIG. 2 illustrates an example environment including examples of landmarks. For example, landmark environment 200, comprises a WiFi hotspot 202 a hotspot location, an intersection 204 at a first intersection location, an intersection 206 at a second intersection location, a near field communication (NFC) reader 208 at a reader location, and landmark building 210 at a building location. A user may follow a path 212 comprising path segments illustrated by dashed lines.

For example, a user may begin walking path 212 near WiFi hotspot 202 carrying a mobile device that determines WiFi hotspot 202 is near. For example, the WiFi hotspot may be detected, for example, by a received signal strength (RSS), where a peak value of the RSS may correspond to the user reaching the landmark. The user continues and/or traverses along path segment 214 to intersection 204, where the user makes a right hand turn. The user walks along path segment 216 to the end of the block to intersection 206, where the user turns to the left and proceeds along path segment 218 to NFC reader 208. The user may then turn left after having something read by NFC reader 208 and proceed along path segment 220 to landmark building 210. As a non-limiting example, the user may use a feature of the mobile device to communicate that the user is located at landmark building 210. For example, a user may post a remark on a media service that the user “is at”, “is near”, “was at”, “meeting at”, “checked in at” and/or “is going to” landmark building 210. Additionally or alternative, a mobile device carried by the user may receive a GPS location at the any of the discussed locations or at an independent location. The GPS information may also be used as a landmark.

Various embodiments contemplate using such landmark data to adjust a step length estimation model. For example, a step length estimation model 132 may take the landmark data and the associated estimated step lengths between the landmarks. For example, the user made a turn at intersection 204 that may trigger the system to identify the nearest intersection according to a map a landmark. The system may also identify the turn made by the user at intersection 206 as another landmark. The system may determine the distance between the intersections based on a map or other recorded data about the location of the intersections to determine a ground distance and compare that distance to an aggregation of estimated step lengths over the time period between the identification of the turns made by the user. These two values may combine to form a tuple for the system to use in solving for a correction coefficient as discussed.

Various embodiments contemplate that various types of landmarks may be more accurate than others. For example, a turn at intersection 206 may be detected, however, a user may make a gradual turn as compared to a sharp turn. This may add an error amount to the location of the turn. Similarly, the user may cross a street before turning adding an additional error amount to the location of the turn.

Various embodiments consider these intrinsic errors. For example, a tuple may have a confidence level associated with it. For example, a longer straight line between two turns may have higher confidence level than a shorter distance between two turns since an error ratio brought by above unknowns that may introduce an error may be smaller. Additionally, a landmark based on a reading by a NFC reader may provide a more accurate location than the intersection example, since, for example, the location of an NFC reader may be known with a level of accuracy, and the user may be required to be within a certain range of the NFC reader for the reader to read. These, and other factors, may lead to a higher level of confidence to be associated with landmark data associated with an NFC reader when compared to landmark data associated with an intersection. It is understood that other factors may influence the confidence level where many depend on specific scenarios and underlying algorithms.

In various embodiments, the step detection, step length estimation, and personalization system 106 may include a step length readjustment module 134. The step length readjustment module 134 may be configured to readjust the estimated length of a detected step. In one embodiment, the step length readjustment module 134 may adjust the step model to effect a step length estimation adjustment.

In some situations, after a generic model has been adjusted or personalized for a specific person, the model may or may not remain static. For example, a user may change his or her pedestrian model over time. This may be caused by various factors including, but not limited to, wearing different shoes, walking in areas with different types of ground, carrying additional weight or objects, or receive an injury. Various embodiments contemplate continuously adjusting a compensation coefficient. In some cases, however, a user's pedestrian model may not change frequently enough to warrant a continuously updating model. Other embodiments contemplate, that after an adjustment or personalization process determines a value of compensation coefficient becomes stable, the system may monitor the error ratio between the personalized model and ground truth. If the error ratio exceeds a threshold level, the system may trigger the re-personalization or personalization process again. Various embodiments contemplate monitoring the error ratio continuously, at predetermined time intervals, after the passage of a predetermined time since a previous error value was determined, and/or when new landmark data is received. Additionally or alternatively, the system may trigger the re-personalization or personalization process again if errors that exceed a threshold are detected with a frequency that exceeds a threshold frequency. Additionally or alternatively, the system may trigger the re-personalization or personalization process again.

In various embodiments, the step length adjustment module 132 and/or the step length readjustment module 134 may be used in an offline mode, and online mode, or a combination thereof. For example, in an offline mode, the step length adjustment module 132 and/or the step length readjustment model 134 may be configured to adjust the estimated length of a detected step by collecting sensor data from sensors 120 during an excursion or walk where the adjustment may be made after the excursion or walk has concluded. The sensor data collected may be combined with and/or compared to other location data to adjust the step model. Additionally or alternatively, the data collected may be used to build a location database and may be used to correlate a sensor reading or other data to a location. For example, the database may be developed to bind an environmental signal to a physical location. An environmental signal may include, but is not limited to, an intensity of a magnetic field, a photograph, a WiFi signal, and the like. Additionally or alternatively, an online mode may adjust a step length model during an excursion or walk using data collected from sensors, a local database, and/or a remote database. Various embodiments contemplate that if personal information such as location information, landmark data, adjusted models is stored or transmitted the user may have an opportunity to decide to allow the collection, storage, and/or transmittal, and/or an opportunity to discontinue the same. Various embodiments contemplate that if personal information is stored or transmitted, adequate security measures and features are in place to secure the personal data.

### Illustrative Computing Device and Illustrative Operational Environment

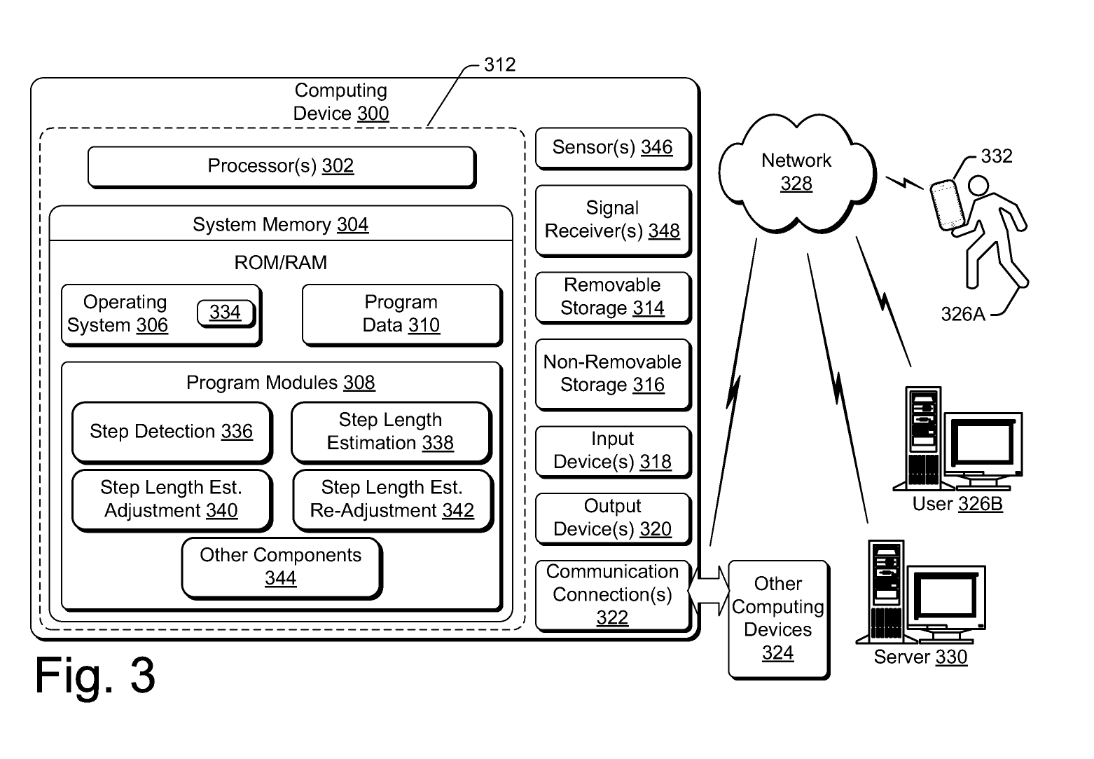

FIG. 3 illustrates a representative computing device 300 that may, but need not necessarily be used to, implement the system and methods described herein, in accordance with various embodiments. The techniques and mechanisms described herein may be implemented by multiple instances of computing device 300 as well as by any other computing device, system, and/or environment. The computing device 300 shown in FIG. 3 is only one example of a computing device and is not intended to suggest any limitation as to the scope of use or functionality of any computing device utilized to perform the processes and/or procedures described above.

In at least one configuration, the computing device 300 includes at least one processor 302 and system memory 304. The processor(s) 302 may execute one or more modules and/or processes to cause the computing device 300 to perform a variety of functions and/or control a variety of methods. In some embodiments, the processor(s) 302 may include a central processing unit (CPU), a graphics processing unit (GPU), both CPU and GPU, or other processing units or components known in the art. Additionally, each of the processor(s) 302 may possess its own local memory, which also may store program modules, program data, and/or one or more operating systems.

Depending on the exact configuration and type of the computing device 300, the system memory 304 may be volatile (such as RAM), non-volatile (such as ROM, flash memory, miniature hard drive, memory card, or the like) or some combination thereof. The system memory 304 may include an operating system 306, one or more program modules 308, and may include program data 310. The operating system 306 includes a component-based framework 334 that supports components (including properties and events), objects, inheritance, polymorphism, reflection, and provides an object-oriented component-based application programming interface (API). The computing device 300 is of a very basic illustrative configuration demarcated by a dashed line 312. Again, a terminal may have fewer components but may interact with a computing device that may have such a basic configuration.

Program modules 308 may include, but are not limited to, step detection 336, step length estimation 338, step length adjustment 340, step length readjustment 342, and/or other components 344.

The computing device 300 may have additional features and/or functionality. For example, the computing device 300 may also include additional data storage devices (removable and/or non-removable) such as, for example, magnetic disks, optical disks, or tape. Such additional storage is illustrated in FIG. 3 by removable storage 314 and non-removable storage 316.

The storage devices and any associated computer-readable media may provide storage of computer readable instructions, data structures, program modules, and other data. Computer-readable media includes, at least, two types of computer-readable media, namely computer storage media and communications media.

Computer storage media includes volatile and non-volatile, removable and non-removable media implemented in any method or technology for storage of information such as computer readable instructions, data structures, program modules, or other data.

Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that may be used to store information for access by a computing device.

In contrast, communication media may embody computer readable instructions, data structures, program modules, or other data in a modulated data signal, such as a carrier wave, or other transmission mechanism. As defined herein, computer storage media does not include communication media.

Moreover, the computer-readable media may include computer-executable instructions that, when executed by the processor(s) 302, perform various functions and/or operations described herein.

The computing device 300 may also have input device(s) 318 such as a keyboard, a mouse, a pen, a voice input device, a touch input device, and the like Output device(s) 320, such as a display, speakers, a printer, and the like may also be included.

The computing device 300 may also contain communication connections 322 that allow the device to communicate with other computing devices 324, such as over a network. By way of example, and not limitation, communication media and communication connections include wired media such as a wired network or direct-wired connections, and wireless media such as acoustic, radio frequency (RF), infrared, and other wireless media. The communication connections 322 are some examples of communication media. Communication media may typically be embodied by computer readable instructions, data structures, program modules, and the like.

FIG. 3 also shows a schematic diagram of an illustrative operating environment where an illustrative system may operate. For example, various embodiments of the system may operate on the computing device 300. The computing device 300 may interact with a user 326A and/or B directly or indirectly. The computing device may be connected to a network 328. The network device 328 may provide access to other computing devices 324 including a server 330, mobile devices 332, and/or other connections and/or resources. Connections may be wired or wireless.

The computing device 300 may also comprise one or more sensors 346 and may contain one or more signal receivers 348. For example, sensors 346 may obtain sensor data that represents movement of the user 326A. In one embodiment, the one or more sensors may include, but are not limited to, an accelerometer, a pedometer, a digital compass, a gyroscope, a network signal detector, and the like.

The illustrated computing device 300 is only one example of a suitable device and is not intended to suggest any limitation as to the scope of use or functionality of the various embodiments described. Other well-known computing devices, systems, environments and/or configurations that may be suitable for use with the embodiments include, but are not limited to, personal computers, server computers, hand-held or laptop devices, multiprocessor systems, microprocessor-based systems, set top boxes, game consoles, programmable consumer electronics, network PCs, minicomputers, mainframe computers, distributed computing environments that include any of the above systems or devices, implementations using field programmable gate arrays (“FPGAs”) and application specific integrated circuits (“ASICs”), and/or the like.

The implementation and administration of a shared resource computing environment on a single computing device may enable multiple computer users to concurrently collaborate on the same computing task or share in the same computing experience without reliance on networking hardware such as, but not limited to, network interface cards, hubs, routers, servers, bridges, switches, and other components commonly associated with communications over the Internet, as well without reliance on the software applications and protocols for communication over the Internet.

### Illustrative Processes

For ease of understanding, the processes discussed in this disclosure are delineated as separate operations represented as independent blocks. However, these separately delineated operations should not be construed as necessarily order dependent in their performance. The order in which the processes are described is not intended to be construed as a limitation, and any number of the described process blocks may be combined in any order to implement the process, or an alternate process. Moreover, it is also possible that one or more of the provided operations may be modified or omitted.

The processes are illustrated as a collection of blocks in logical flowcharts, which represent a sequence of operations that may be implemented in hardware, software, or a combination of hardware and software. For discussion purposes, the processes are described with reference to the system shown in FIGS. 1-3. However, the processes may be performed using different architectures and devices.

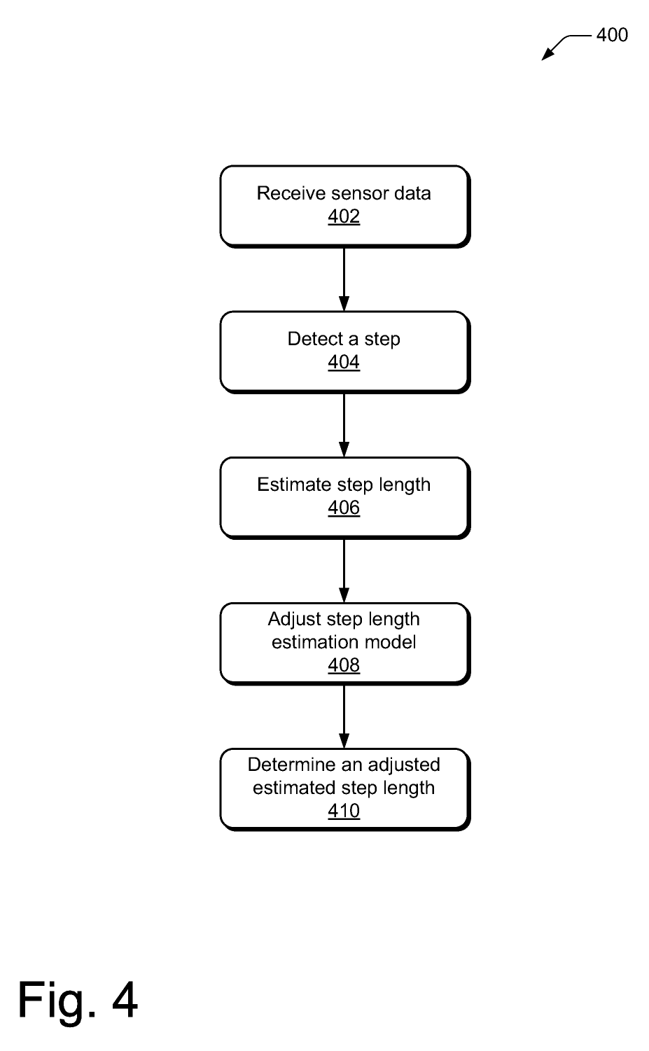

FIG. 4 is a flowchart of an illustrative process 400 of estimating a step length. For example, at 402 sensor data may be received. In various embodiments, the sensor data may comprise accelerometer data and/or landmark data.

At 404, a step may be detected. For example, a step may be detected based at least in part on the sensor data. For example, accelerometer data received may be processed and evaluated to detect a step cycle.

At 406, a step length may be estimated. For example, a step length may be estimated based at least in part on the sensor data. Various embodiments contemplate estimating a step length based at least in part on a step length estimation model.

At 408, the estimated step length may be adjusted. For example, the estimated step length may be adjusted or personalized based at least in part on the sensor data. Various embodiments contemplate adjusting a step length estimation model. For example, adjustments may be made to a generic step estimation model that may personalize or adjust the generic model to better estimate the step length of the user.

At 410, an adjusted estimated step length may be determined. For example, using an adjusted or personalized step length estimation model, an adjusted step length may be determined.

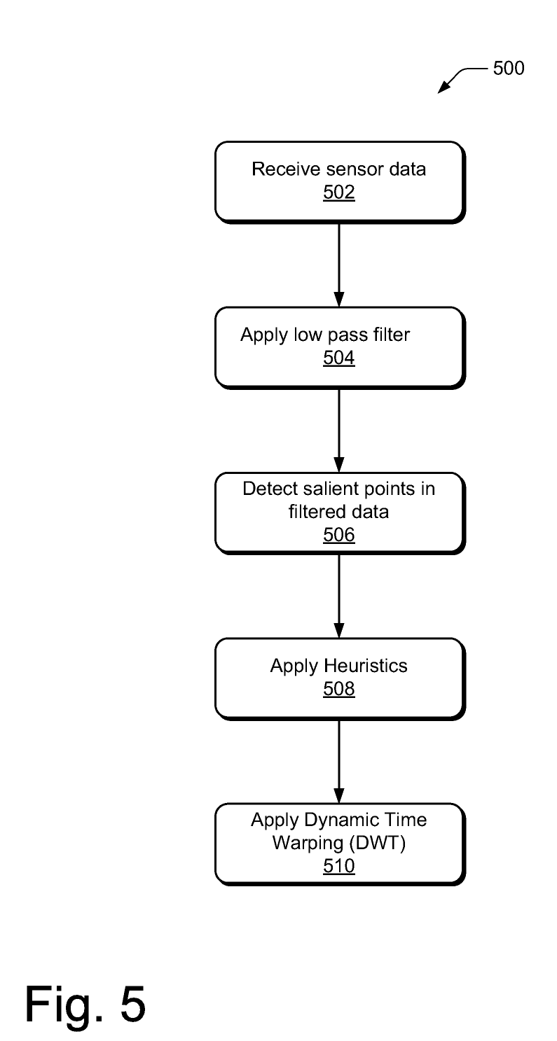

FIG. 5 is a flowchart of an illustrative process 500 of processing data to detect a step. For example, at 502 sensor data may be received. In various embodiments, the sensor data may comprise accelerometer data.

At 504, a low pass filter may be applied to the accelerometer data or a magnitude of the accelerometer data. Various embodiments contemplate applying a low pass filter to eliminate frequencies that exceed a step cadence of a user. For example, a user often walks at a frequency below approximately 3 Hz.

At 506, salient points may be detected in the filtered accelerometer data. For example, a peak, a valley, and/or a zero crossing may be used to identify a salient point. Various embodiments contemplate that each salient point may be representative of a step taken by a user. However, the salient points may include data that reflect data noise or other features that may cause an erroneous step to be counted.

At 508, the identified salient points may be further limited by applying heuristics and/or heuristic constraints to identify or eliminate possible erroneous steps reflected in the data. Various embodiments contemplate applying a heuristic that limits the data representative of a step to be spaced sufficiently separate from each other. For example, a step may be expected to have an appropriate time gap between it and an adjacent step. This time gap may have an upper threshold and a lower threshold. For example, an upper threshold may be approximately 1 second and a minimum threshold may be approximately ⅓ of a second. Additionally or alternatively, various embodiments contemplate applying a heuristic that limits the data representative of a step to have a sufficient difference in acceleration. For example, a difference in magnitudes of the acceleration across the duration of a step may need to exceed a threshold. For example, data representing a step by a user may have to exceed a thresholdValue*gravity to be counted as a step, where thresholdValue may depend on the location of the sensor. For example, a sensor may correspond to a thresholdValue between 0.1 and 0.5. Additionally or alternatively, various embodiments contemplate that a sensor located in a certain location on a user may correspond to various thresholdValues. For example, a sensor located in a user's pocket may correspond to a larger thresholdValue relative to a sensor located in a user's hand. For example, a sensor located in a user's pocket may correspond to a thresholdValue of 0.4. Additionally or alternatively, a sensor located in a user's hand may correspond to a thresholdValue of 0.2. For example, an acceleration that exceeds 0.2 G may represent a step when a sensor is located in a user's hand. Additionally or alternatively, acceleration that exceeds 0.4 G may represent a step when a sensor is located in a user's pocket.

At 510, the identified salient points may be further limited by applying dynamic time warping (DTW) to identify or eliminate possible erroneous steps reflected in the data. Various embodiments contemplate applying a DTW where wave forms of candidate steps may be compared. For example, a user often walks with alternating feet. Therefore, DTW may be applied to candidate steps associated with the same foot (right or left) to calculate a similarity factor. In various embodiments, if the similarity factor is below a threshold, then the candidate step may be considered a step.

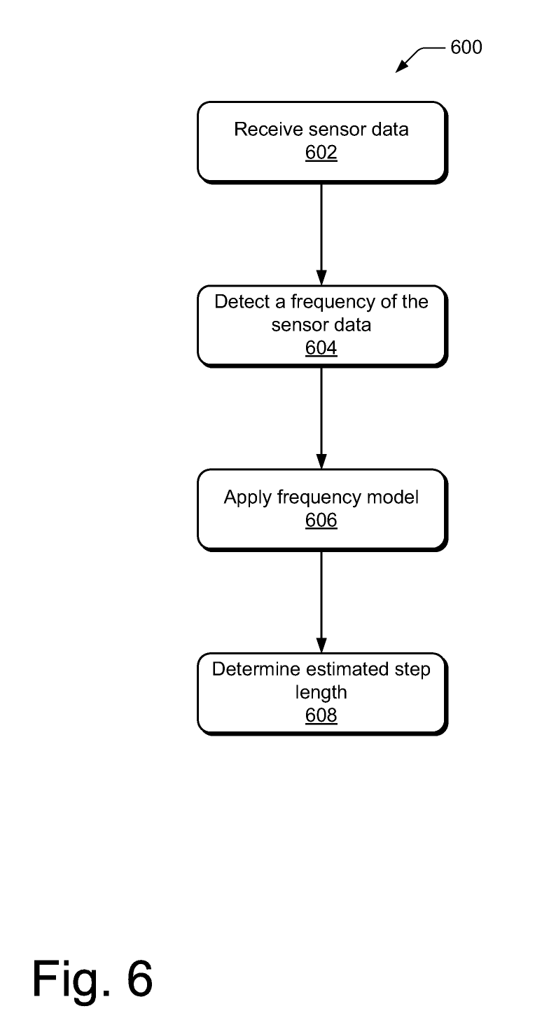

FIG. 6 is a flowchart of an illustrative process 600 of estimating a step length. For example, at 602 sensor data may be received. In various embodiments, the sensor data may comprise accelerometer data that has been processed using steps similar to those discussed with respect to FIG. 5.

At 604, a frequency of the sensor data or processed sensor data may be detected.

At 606, a frequency model may be applied to the data. Various embodiments contemplate a frequency based model comprising a linear combination of adjacent step frequencies. Each term of the linear combination may have a scaling factor associated with each frequency that may be based at least in part on a generic frequency model. The generic frequency model may be trained using data from a wide variety of potential users across a wide variety of conditions and circumstances. Additionally or alternatively, the frequency based model may have many terms, it may have non-linear terms, or it may be of a higher order altogether.

At 608, an estimated step length may be determined. For example, the step length may be determined based at least in part on the frequency model as applied to the sensor data.

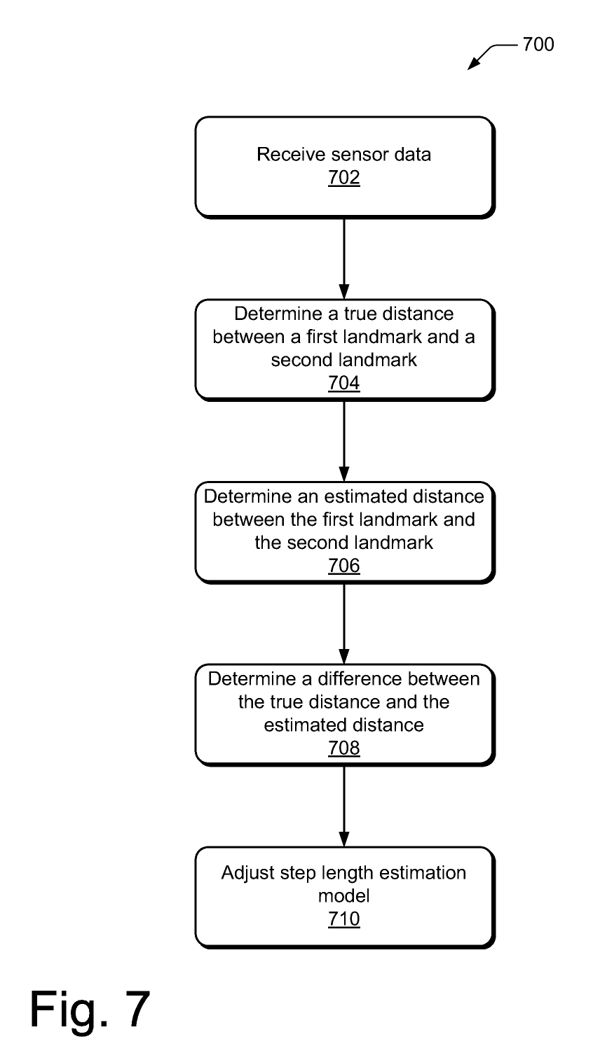

FIG. 7 is a flowchart of an illustrative process 700 of adjusting an estimated step length. For example, at 602 sensor data may be received. In various embodiments, the sensor data may comprise accelerometer data that has been processed using steps similar to those discussed with respect to FIG. 5. Additionally or alternatively, sensor data may comprise landmark data. For example, landmark data may comprise a location of a first and second landmark near a user at a known first and second time respectively.

At 704, a true distance between a first landmark and a second landmark may be determined.

At 706, an estimated distance between the first landmark and the second landmark may be determined. For example, an estimated distance may be based at least in part on an aggregation of the estimated step lengths determined between the first time when the user was near the first landmark and the second time when the user was near the second landmark.

At 708, a difference between the true distance and the estimated distance may be determined.

At 710, the step length estimation model may be adjusted based at least in part on the difference between the true distance and the estimated distance. Various embodiments contemplate using a plurality of differences between estimated distances and true distances for a plurality of landmark data sets.

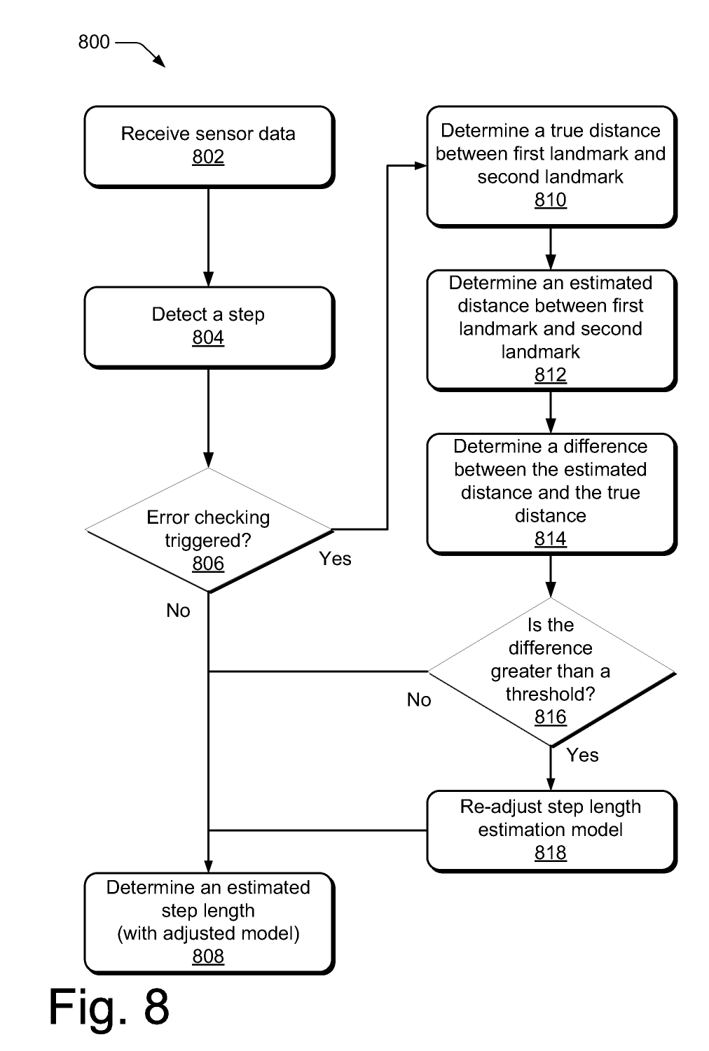

FIG. 8 is a flowchart of an illustrative process 800 of readjusting an estimated step length. For example, at 802 sensor data may be received. In various embodiments, the sensor data may comprise accelerometer data that has been processed using steps similar to those discussed with respect to FIG. 5 and landmark data similar to that discussed with respect to FIG. 7.

At 804, a step may be detected. Various embodiments contemplate detecting a step using methods similar to those discussed with respect to FIGS. 4 and 5.

At 806, if an error checking process is not triggered, then the process may continue to 808 where an estimated step length may be determined using the step length model. Various embodiments contemplate that the step length model used at 808 may be the original step length estimation model or a model that has been adjusted one or more times.

At 806, if an error checking process is triggered, the process may check for errors. Various embodiments contemplate triggering an error checking when, for example, a predetermined amount of time has elapsed since the last error check was triggered, a user has changed, a user has changed a characteristic of the user (e.g., shoes, running style, and the like), or a combination thereof.

At 810, a true distance between a first landmark and a second landmark may be determined.

At 812, an estimated distance between the first landmark and the second landmark may be determined. For example, an estimated distance may be based at least in part on an aggregation of the estimated step lengths determined between the first time when the user was near the first landmark and the second time when the user was near the second landmark.

At 814, a difference between the true distance and the estimated distance may be determined.

At 816, if the difference between the true distance and the estimated distance is lower than a threshold, then the process may continue to 808 where an estimated step length may be determined using the step length model.

At 816, if the difference between the true distance and the estimated distance is lower than a threshold, then the process may continue to 818 where the step length estimation model may be adjusted based at least in part on the difference between the true distance and the estimated distance. Various embodiments contemplate using a plurality of differences between estimated distances and true distances for a plurality of landmark data sets. After the step length model is adjusted, the process may continue to 808 where an estimated step length may be determined using the step length model.

### CONCLUSION

The subject matter described above can be implemented in hardware, software, or in both hardware and software. Although implementations have been described in language specific to structural features and/or methodological acts, it is to be understood that the subject matter defined in the appended claims is not necessarily limited to the specific features or acts described above. Rather, the specific features and acts are disclosed as example forms of implementing the claims. For example, the methodological acts need not be performed in the order or combinations described herein, and may be performed in any combination of one or more acts.

What is claimed is:

1. A method of estimating a step length, comprising:
under control of one or more processors configured with executable instructions:
receiving, from one or more sensors, one or more databases, or a combination thereof, sensor data comprising accelerometer data and landmark data;
detecting a step based at least in part on the accelerometer data;
estimating a step length based at least in part on the accelerometer data; and
adjusting the estimated step length based at least in part on the accelerometer data and the landmark data.

2. The method of claim 1, wherein the detecting the step comprises:
processing the accelerometer data; and
evaluating the processed accelerometer data to detect a cycle.

3. The method of claim 2, wherein the evaluating the processed accelerometer data comprises detecting salient points in the processed accelerometer data.

4. The method of claim 2, wherein the processing the accelerometer data comprises:
applying one or more low pass filters;
applying one or more heuristic constraints; and
applying one or more dynamic time warping operations to compare wave forms.

5. The method of claim 1, wherein the estimating the step length comprises:
estimating a step frequency from the sensor data; and
calculating the step length of the step based at least in part on the step frequency and a predetermined function of the sensor data.

6. The method of claim 1, wherein the estimating the step length comprises:
processing the accelerometer data; and
evaluating the processed accelerometer data to detect frequency of a cycle.

7. The method of claim 6, wherein the evaluating the processed accelerometer data to detect frequency of the cycle comprises applying a frequency model, wherein the frequency model is based at least in part on a linear combination of a first frequency of a first step candidate at a first time and a second frequency of a second step candidate at a second time.

8. The method of claim 1, wherein the adjusting the estimated step length comprises:
determining a true distance between a first landmark and a second landmark;
determining an estimated distance between the first landmark and the second landmark based in part on an aggregation of estimated step lengths over a traversal between the first landmark and the second landmark;
adjusting the estimated step length based at least in part on a difference between the estimated distance and the true distance.

9. The method of claim 1, wherein the estimating a step length comprises:
processing the accelerometer data;
evaluating the processed accelerometer data to detect frequency of a cycle;
applying a step length estimation model.

10. The method of claim 9, wherein the adjusting the estimated step length comprises:
determining a true distance between a first landmark and a second landmark based at least in part on the landmark data;
determining an estimated distance between the first landmark and the second landmark based in part on an aggregation of estimated step lengths over a traversal between the first landmark and the second landmark;
determining a distance between the estimated distance and the true distance; and
adjusting the step length estimation model based at least in part on the difference between the estimated distance and the true distance.

11. The method of claim 10, wherein the landmark data comprises location information of a landmark and a confidence level associated with the landmark data.

12. The method of claim 11, wherein a landmark comprises one or more of a physical structure, an intersection, a communication tower, a near field communication reader, or a peak value of a received signal strength.

13. The method of claim 10, further comprising readjusting the step length estimation model based at least in part on a difference between the estimated distance and the true distance.

14. The method of claim 13, wherein the readjusting is initiated in response to a detected error value between a determined true distance and a determined estimated distance that exceeds a predetermined threshold value.

15. The method of claim 14, further comprising determining the error value in response to one or more of a passage of a predetermined time since a previous error value determination or new landmark data is received.

16. One or more computer-readable media configured with computer-executable instructions that, when executed by one or more processors, configure the one or more processors to perform acts comprising:
receiving, from one or more sensors, one or more databases, or a combination thereof, sensor data comprising accelerometer data and landmark data;
detecting a step based at least in part on the accelerometer data;
estimating a step length based at least in part on the accelerometer data and a step length estimation model;
adjusting the step length estimation model based at least in part on the accelerometer data and the landmark data; and
determining an adjusted estimated step length.

17. The one or more computer-readable media of claim 16, wherein the landmark data comprises location information for a first landmark and a second landmark, and wherein the adjusting the step length estimation model comprises:
determining a true distance between the first landmark and the second landmark based at least in part on the landmark data;
determining an estimated distance between the first landmark and the second landmark based in part on an aggregation of estimated step lengths over a traversal between the first landmark and the second landmark;
determining a distance between the estimated distance and the true distance; and
adjusting the step length estimation model based at least in part on the difference between the estimated distance and the true distance.

18. The one or more computer-readable media of claim 17, further comprising:
determining a difference between a determined true distance and a determined estimated distance in response to a trigger, wherein the trigger comprises one or more of a lapse of a time period since a preceding determination of the difference or new landmark data is received; and
readjusting the step length estimation model based at least in part on the difference between the true distance and the estimated distance when the difference exceeds a threshold difference.

19. A system comprising:
one or more processors;
memory, communicatively coupled to the one or more processors, storing instructions that, when executed by the one or more processors, configure the one or more processors to perform acts comprising:
receiving sensor data comprising accelerometer data and landmark data from one or more sensors;
detecting a step based at least in part on the sensor data;
estimating a step length based at least in part on the sensor data and a step length estimation model;
adjusting the step length estimation model based at least in part on the sensor data comprising:
determining a true distance between the first landmark and the second landmark based at least in part on the landmark data;
determining an estimated distance between the first landmark and the second landmark based in part on an aggregation of estimated step lengths over a traversal between the first landmark and the second landmark;
determining a distance between the estimated distance and the true distance; and
adjusting the step length estimation model based at least in part on the difference between the estimated distance and the true distance; and
determining an adjusted estimated step length.

20. The one or more computer-readable media of claim 19, further comprising:
determining a difference between a determined true distance and a determined estimated distance in response to a trigger, wherein the trigger comprises one or more of a lapse of a time period since a preceding determination of the difference or new landmark data is received; and
readjusting the step length estimation model based at least in part on the difference between the true distance and the estimated distance when the difference exceeds a threshold difference.
